(19) United States
(12) Patent Application Publication
(10) Pub. No.: US 2025/0203224 A1
(43) Pub. Date: Jun. 19, 2025

(54) CAMERA CLEANING CONTROL METHOD AND APPARATUS, DEVICE, AND SYSTEM

(71) Applicant: Cambricon SingGo (Nanjing) Technology Co, Ltd., Nanjing (CN)

(72) Inventors: Yanjun ZHAO, Nanjing (CN); Guang JIANG, Nanjing (CN)

(21) Appl. No.: 18/687,444

(22) PCT Filed: Jun. 6, 2022
(86) PCT No.: PCT/CN2022/097201

§ 371 Date: Feb. 25, 2025

(30) Foreign Application Priority Data
Sep. 1, 2021 (CN) 202111020097.9
Sep. 1, 2021 (CN) 202111020424.0

(51) Int. Cl. H04N 23/81; G02B 27/00; G03B 17/14; H04N 23/52; H04N 23/60

(52) U.S. Cl. CPC H04N 23/811; G02B 27/0006; G03B 17/14; H04N 23/52; H04N 23/665

(57) ABSTRACT

The present disclosure provides a camera cleaning control method, apparatus, device, and system. The method includes: determining a target camera that is currently required to be cleaned, determining a cleaning period of the target camera according to a synchronization signal, and cleaning the target camera during the cleaning period. The disclosed method may clean the target camera without affecting the image acquisition of the target camera.

The present application claims priority to Chinese Patent Application No. 202111020424.0 with the title of “Camera Cleaning Control Method, Apparatus, Device, and System” and filed on Sep. 1, 2021 and Chinese Patent Application No. 202111020097.9 with the title of “Camera Cleaning Method, Apparatus, Device, and Readable Storage Medium” and filed on Sep. 1, 2021, the disclosures of which are incorporated herein in their entirety by reference.

### TECHNICAL FIELD

The present disclosure relates to the technical field of vehicle assembly and, more specifically, to a camera cleaning control method, apparatus, device, and system.

### BACKGROUND

With the development of vehicle assembly technology, more and more vehicles are equipped with vehicle camera cleaning apparatuses, thereby implementing the cleaning of vehicle cameras.

At present, a common camera cleaning control method is to detect whether a camera is required to be cleaned, and if the camera is required to be cleaned, the camera is cleaned. However, cleaning the camera using the above camera cleaning control method will affect the image acquisition of the camera, thus affecting driving experience.

### SUMMARY

The purpose of this application is to provide a camera cleaning control method, apparatus, device, and system to implement camera cleaning without affecting camera image acquisition.

A first aspect of the present disclosure discloses a camera cleaning control method, including: determining a target camera that is currently required to be cleaned; determining a cleaning period of the target camera according to a synchronization signal; and cleaning the target camera during the cleaning period.

In an implementation, the camera is equipped with a plurality of lenses; determining the target camera that is currently required to be cleaned includes: determining the target camera that is currently required to be cleaned, where the target camera currently uses a first lens; determining the cleaning period of the target camera according to the synchronization signal includes: determining a switching period of the first lens according to the synchronization signal, where the switching period is within a period from the end of the exposure of a current frame to the beginning of the acquisition of a next frame, and a period after completion of the switching is a cleaning period of the first lens; and cleaning the target camera during the cleaning period includes: switching the currently used lens to a second lens during the switching period, and cleaning the first lens after the switching is completed, where the second lens is a lens other than the first lens among the plurality of lenses arranged in the camera.

In an implementation, determining the cleaning period of the target camera according to the synchronization signal includes: determining the cleaning period of the target camera according to the synchronization signal, where the cleaning period is within the period from the end of the exposure of the current frame to the beginning of the acquisition of the next frame.

A second aspect of the present disclosure discloses a camera cleaning control apparatus, including: a determining unit configured to determine a target camera that is currently required to be cleaned and determine a cleaning period of the target camera according to a synchronization signal; and a processing unit configured to clean the target camera during the cleaning period.

In an implementation, the determining unit is specifically configured to determine the target camera that is currently required to be cleaned, where the target camera currently uses a first lens; the determining unit is further specifically configured to determine a switching period of the first lens according to the synchronization signal, where the switching period is within a period from the end of the exposure of a current frame to the beginning of the acquisition of a next frame, and a period after completion of the switching is a cleaning period of the first lens; and the processing unit is specifically configured to switch the currently used lens to a second lens during the switching period and clean the first lens after the switching is completed, where the second lens is a lens other than the first lens among a plurality of lenses arranged in the camera.

In an implementation, the processing unit includes a control unit; the determining unit is specifically configured to determine the cleaning period of the target camera according to the synchronization signal, where the cleaning period is within the period from the end of the exposure of the current frame to the beginning of the acquisition of the next frame; and the control unit is configured to clean the target camera during the cleaning period.

A third aspect of the present disclosure discloses an electronic device, including: a memory and a processor, where the memory is configured to store an executable instruction of the processor, where the processor is configured to call a program instruction in the memory to perform the camera cleaning control method described above.

A fourth aspect of the present disclosure discloses a computer-readable storage medium, on which a computer execution instruction is stored, where the camera cleaning control method described above is implemented when the computer execution instruction is executed by a processor.

A fifth aspect of the present disclosure discloses a computer program product, including a computer program, where the camera cleaning control method described above is implemented when the computer program is executed by a processor.

A sixth aspect of the present disclosure discloses a camera cleaning system, including: a cleaning control apparatus, a plurality of cleaning apparatuses, a frame sync generator, and a plurality of cameras. The plurality of cleaning apparatuses are arranged in one-to-one correspondence with the plurality of cameras. The frame sync generator is connected to the cleaning control apparatus and is configured to generate and send a synchronization signal to the cleaning control apparatus. The cleaning control apparatus is connected to the plurality of cleaning apparatuses and is configured to: determine a target camera that is currently required to be cleaned, determine a cleaning period of the target camera according to the synchronization signal, where the cleaning period is within a period from the end of the exposure of a current frame to the beginning of the acquisition of a next frame, and control a cleaning apparatus corresponding to the target camera to clean the target camera during the cleaning period.

In an implementation, the system further includes: a plurality of serializers that are arranged in one-to-one correspondence with the plurality of cameras, where one end of the plurality of serializers is connected to the frame sync generator, the other end of the plurality of serializers is connected to the plurality of cameras one by one, and the other end of at least one serializer is connected to the cleaning control apparatus. The plurality of serializers are configured to synchronously output the synchronization signal generated by the frame sync generator to the plurality of cameras and the cleaning control apparatus.

In combination with the above technical scheme, this application provides a camera cleaning control method, apparatus, device, and system to determine a target camera that is currently required to be cleaned, determine a cleaning period of the target camera according to a synchronization signal, and clean the target camera during the cleaning period. In other words, this application may determine the cleaning period of the target camera according to the synchronization signal, so as to ensure that the target camera is cleaned during the cleaning period determined thereby, and the image acquisition of the target camera will not be affected.

### BRIEF DESCRIPTION OF DRAWINGS

FIG. 1 is a flowchart of a camera cleaning control method according to an embodiment of the present disclosure.

FIG. 2 is a flow diagram of a camera cleaning control method according to an embodiment of the present disclosure.

FIG. 3 is a flowchart of a camera cleaning control method according to an embodiment of the present disclosure.

FIG. 4 is a working sequence diagram of a camera according to an embodiment of the present disclosure.

FIG. 5 is an exposure diagram of a camera according to an embodiment of the present disclosure.

FIG. 6 is a flowchart of a camera cleaning control method according to an embodiment of the present disclosure.

FIG. 7 is a flowchart of a camera cleaning control method according to an embodiment of the present disclosure.

FIG. 8 is a schematic diagram of a switching apparatus according to an embodiment of the present disclosure.

FIG. 9 is a structure diagram of a camera cleaning control apparatus according to an embodiment of the present disclosure.

FIG. 10 is a structure diagram of a camera cleaning control apparatus according to an embodiment of the present disclosure.

FIG. 11 is a schematic diagram of a camera cleaning control system according to an embodiment of the present disclosure.

FIG. 12 is a schematic diagram of a working principle of a serializer according to an embodiment of the present disclosure.

FIG. 13 is a structural diagram of an electronic device according to an embodiment of the present disclosure.

### DETAILED DESCRIPTION

With the development of vehicle assembly technology, more and more vehicles are equipped with vehicle camera cleaning apparatuses, thereby implementing the cleaning of vehicle cameras.

At present, a common camera cleaning control method is to detect whether a camera is required to be cleaned, and if the camera is required to be cleaned, the camera is cleaned immediately. However, since the camera is required to perform image acquisition according to a predetermined working sequence at work, cleaning the camera using the above camera cleaning control method may lead to blurred or even abnormal images acquired by the camera. Especially in the scenario of automatic driving, if the images acquired by the camera are abnormal, not only driving experience will be affected, but also driving safety will be affected.

The camera cleaning control method, apparatus, device, and system provided in this application are intended to solve the above technical problems in the prior art.

The technical scheme of this application and how the technical scheme of this application solves the above technical problems are described in detail below in combination with specific embodiments. The following specific embodiments may be combined with each other, and identical or similar concepts or processes may not be further described in some embodiments. The embodiments of the present disclosure are described in detail below in combination with drawings.

### Embodiment 1

Embodiment 1 of this application provides a camera cleaning control method, including: determining a target camera that is currently required to be cleaned; determining a cleaning period of the target camera according to a synchronization signal; and cleaning the target camera during the cleaning period.

In an example, determining the cleaning period of the target camera according to the synchronization signal includes:
determining the cleaning period of the target camera according to the synchronization signal, where the cleaning period is within a period from the end of the exposure of a current frame to the beginning of the acquisition of a next frame. For details in this example, refer to relevant contents in the embodiment 2 below.

In another example, the camera is equipped with a plurality of lenses; determining the target camera that is currently required to be cleaned includes: determining the target camera that is currently required to be cleaned, where the target camera currently uses a first lens; determining the cleaning period of the target camera according to the synchronization signal includes: determining a switching period of the first lens according to the synchronization signal, where the switching period is within a period from the end of the exposure of a current frame to the beginning of the acquisition of a next frame, and a period after completion of the switching is a cleaning period of the first lens; and cleaning the target camera during the cleaning period includes: switching the currently used lens to a second lens during the switching period, and cleaning the first lens after the switching is completed, where the second lens is a lens other than the first lens among the plurality of lenses arranged in the camera. For details in this example, refer to relevant contents in the embodiment 3 below.

It is required to be noted that an execution body of the camera cleaning control method provided in this embodiment may be a camera cleaning control apparatus. In practical applications, the camera cleaning control apparatus may be implemented by computer programs, such as application software and computer programs, or by media on which related computer programs are stored, such as an USB flash disk and a CD; alternatively, the camera cleaning control apparatus may be implemented by physical apparatuses that integrate or install related computer programs, such as a chip.

### Embodiment 2

FIG. 1 is a flowchart of a camera cleaning control method according to an embodiment of the present disclosure. As shown in FIG. 1, the camera cleaning control method provided by this embodiment includes following steps:
a step 101, determining a target camera that is currently required to be cleaned;
a step 102, determining a cleaning period of the target camera according to a synchronization signal, where the cleaning period is within a period from the end of the exposure of a current frame to the beginning of the acquisition of a next frame; and
a step 103, cleaning the target camera during the cleaning period.

It is required to be noted that an execution body of the camera cleaning control method provided in this embodiment may be a camera cleaning control apparatus. In practical applications, the camera cleaning control apparatus may be implemented by computer programs, such as application software and computer programs, or by media on which related computer programs are stored, such as an USB flash disk and a CD; alternatively, the camera cleaning control apparatus may be implemented by physical apparatuses that integrate or install related computer programs, such as a chip.

In this embodiment, in order to implement camera cleaning without affecting camera image acquisition, it is required to determine a cleaning period according to a synchronization signal of a camera and clean the camera during the cleaning period. Specifically, since there may be a plurality of cameras in a car, such as a front-view camera, a rear-view camera, and a round-view camera, the camera cleaning control apparatus may first determine a target camera that is currently required to be cleaned among the plurality of cameras.

The number of target cameras may be one or more, which is not limited in this embodiment.

In an example, in order to determine the target camera that is currently required to be cleaned, the camera cleaning control apparatus may obtain images acquired by each camera and detect lens attachments of the images acquired by each camera. A specific detection method is not limited in this embodiment. Next, the camera cleaning control apparatus may, according to detection results of the images acquired by each camera, determine a camera whose detection result is that there is an attachment as the target camera that is currently required to be cleaned.

Next, the camera cleaning control apparatus may determine the cleaning period of the target camera according to the synchronization signal. A specific determination method will be detailed in the following and will not be repeated here.

The cleaning period is within the period from the end of the exposure of the current frame to the beginning of the acquisition of the next frame.

It is required to be noted that since there may be synchronization applications between cameras, it is necessary to make each camera work in accordance with the same working sequence, so a signal controlling the work of each camera is synchronized, which is the synchronization signal.

In addition, the current frame refers to a frame that is being processed or has been processed at a current moment, where the processing includes, but is not limited to, acquisition, exposure, and reading.

Finally, the camera cleaning control apparatus may clean the target camera during the cleaning period.

In an example, on the basis of any other example, after the camera cleaning control apparatus cleans the target camera during the cleaning period, the camera cleaning control apparatus may further determine whether the target camera is required to be cleaned again.

Specifically, the camera cleaning control apparatus may obtain an image acquired by the target camera and detect the image. If a detection result of the target camera is that there is an attachment, it is indicated that the target camera is not cleaned cleanly, and the target camera is required to be cleaned again. At this time, the camera cleaning control apparatus may return to the step of determining the cleaning period of the target camera according to the synchronization signal. If the detection result of the target camera is that there is no attachment, it is indicated that the target camera has been cleaned cleanly. At this time, the camera cleaning control apparatus may return to the step of determining the target camera that is currently required to be cleaned.

In the above way, the problem of unclean cleaning of the target camera may be effectively avoided.

In addition, based on the above embodiment 1, in a possible implementation, the camera cleaning control apparatus may clean the target camera using different cleaning methods. Specifically, the camera cleaning control apparatus may first determine a type of attachment corresponding to the target camera. A specific determination method is not limited in this embodiment.

The type of attachment includes, but is not limited to, a raindrop, a snowflake, a stain, and a piece of paper.

Next, the camera cleaning control apparatus may clean the target camera using a corresponding cleaning method according to the type of attachment. The cleaning method includes at least one of followings: water jet cleaning, wiper cleaning, and air jet cleaning. For example, in practical applications, if the type of attachment is the raindrop, the target camera may be cleaned by the wiper cleaning; if the type of attachment is the stain, such as mud, the target camera may be cleaned by the water jet cleaning and the wiper cleaning at the same time; and if the type of attachment is the piece of paper, the target camera may be cleaned by the air jet cleaning.

In the above way, the target camera may be cleaned using corresponding cleaning methods according to different attachment types, so as to ensure cleaning effect.

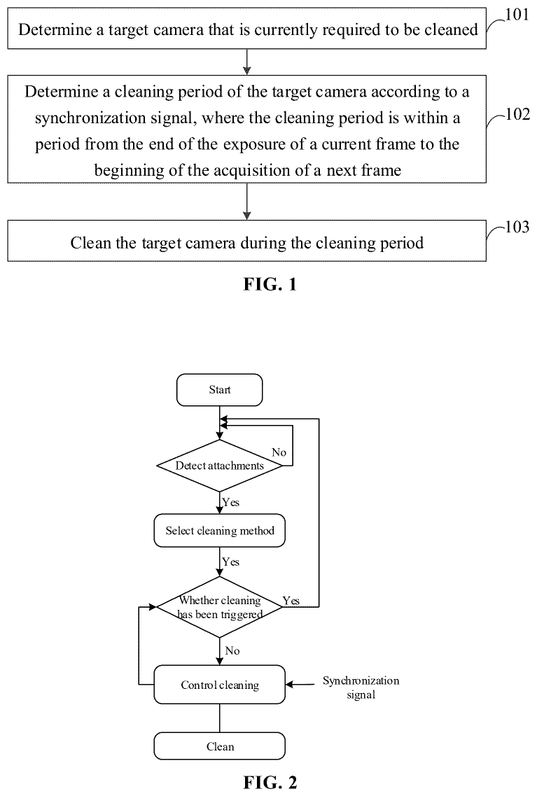

In an example, FIG. 2 is a flow diagram of a camera cleaning control method according to an embodiment of the present disclosure. As shown in FIG. 2, a camera cleaning control apparatus may first detect whether there is an attachment on a lens of each camera; if there is no attachment on the lens of each camera, the camera cleaning control apparatus returns to perform the above detection step; if there is an attachment on the lens of each camera, the camera cleaning control apparatus further detects a type of attachment and selects a corresponding cleaning method according to the type of attachment. After selecting the cleaning method, the camera cleaning control apparatus may determine whether a cleaning process has been triggered, which means that the camera cleaning control apparatus determines whether the camera has been cleaned at this time. If the cleaning process has not been triggered at this time, which means that the camera has not been cleaned at this time, the camera cleaning control apparatus may perform cleaning control according to a synchronization signal (Vsync), which means that the camera cleaning control apparatus determines a cleaning period according to the synchronization signal and cleans a corresponding camera during the cleaning period. After the cleaning is completed, the camera cleaning control apparatus returns to perform the step of determining whether the cleaning process has been triggered. At this time, the cleaning process has been triggered, which means that the camera has been cleaned at this time, and then, the camera cleaning control apparatus returns to perform the step of determining whether there is an attachment on the lens of each camera and further determines whether the camera is required to be cleaned again.

By the camera cleaning control method provided in this embodiment, a target camera that is currently required to be cleaned is determined, a cleaning period of the target camera is determined according to a synchronization signal, where the cleaning period is within a period from the end of the exposure of a current frame to the beginning of the acquisition of a next frame, and the target camera is cleaned during the cleaning period. In other words, in this disclosed embodiment, the period from the end of the exposure of the current frame to the beginning of the acquisition of the next frame may be acquired according to the synchronization signal, and during this period, the cleaning period of the target camera may be determined. Because in this period, information of the current frame has been stored, and the acquisition of the next frame has not started, it is ensured that the cleaning of the target camera during the determined cleaning period will not affect the image acquisition of the target camera.

In another example, the camera cleaning control apparatus may determine a degree of cleaning according to a current weather condition, and clean the target camera to the corresponding degree during the determined cleaning period. Specifically, the camera cleaning control apparatus may determine the current weather condition through an image acquired by the camera, or by obtaining weather data, or by other appropriate methods, which is not limited in this embodiment. For example, if the camera cleaning control apparatus determines that the current weather condition is heavy rain, the camera cleaning control apparatus may clean the target camera during the determined cleaning period, and the degree of cleaning is intensive cleaning. If the camera cleaning control apparatus determines that the current weather condition is fine, the camera cleaning control apparatus may clean the target camera during the determined cleaning period, and the degree of cleaning is ordinary cleaning.

In the above way, the degree of cleaning may be determined according to different weather conditions, so that the target camera may be effectively cleaned, and cleaning effect may be ensured.

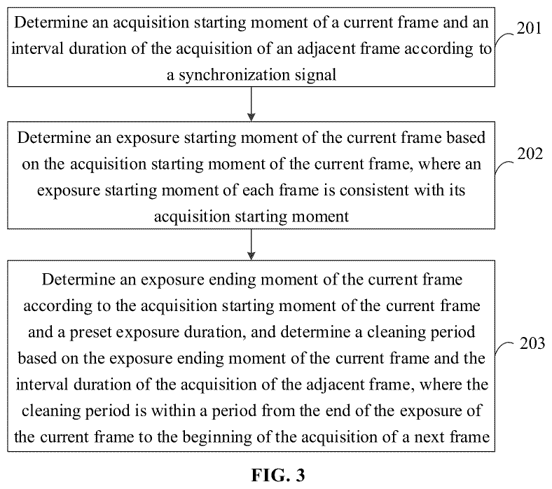

As an example, FIG. 3 is a flowchart of a camera cleaning control method according to an embodiment of the present disclosure. As shown in FIG. 3, the camera cleaning control method provided in this embodiment is based on the above embodiment 2, and the step 102 specifically includes following steps:
a step 201, determining an acquisition starting moment of a current frame and an interval duration of the acquisition of an adjacent frame according to the synchronization signal;
a step 202, determining an exposure starting moment of the current frame based on the acquisition starting moment of the current frame, where an exposure starting moment of each frame is consistent with its acquisition starting moment; and
a step 203, determining an exposure ending moment of the current frame according to the acquisition starting moment of the current frame and a preset exposure duration, and determining the cleaning period based on the exposure ending moment of the current frame and the interval duration of the acquisition of the adjacent frame, where the cleaning period is within the period from the end of the exposure of the current frame to the beginning of the acquisition of the next frame.

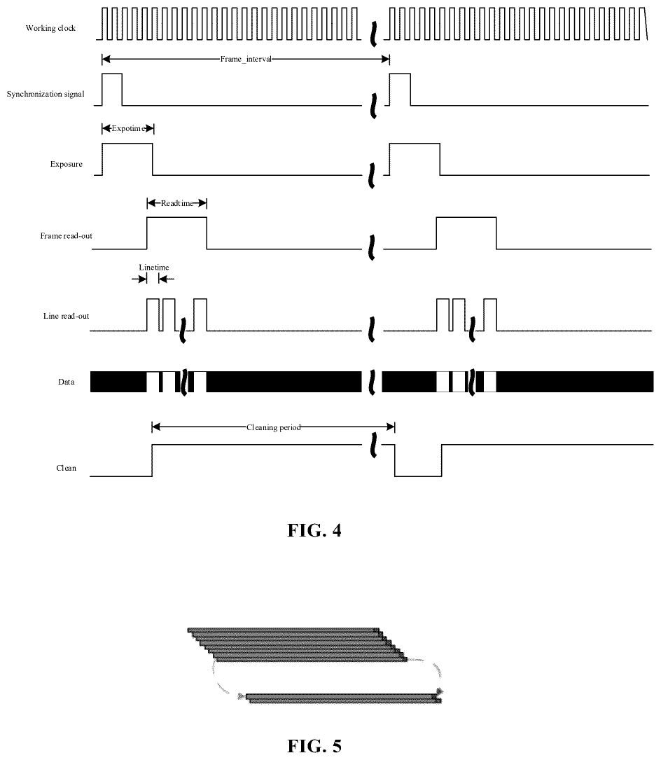

In this disclosed embodiment, the camera cleaning control apparatus may determine the cleaning period of the target camera according to the synchronization signal. Specifically, in an example, FIG. 4 is a working sequence diagram of a camera according to an embodiment of the present disclosure. As shown in FIG. 4, Pclk (peripheral clock) is a working clock inside the camera, which may be doubled by a phase locked loop (PLL) inside the camera according to an external reference clock. Additionally, a working sequence inside the camera is acquired all based on this working clock.

Vsync is a synchronization signal. In a possible implementation, this synchronization signal may be generated within the camera based on the Pclk and frame_interval configuration. In another possible implementation, this synchronization signal may be provided by an external apparatus (such as a sync generator), which may output a synchronization signal at a fixed frequency, such as 30 Hz or 60 Hz.

According to this synchronization signal, the camera cleaning control apparatus may determine the acquisition starting moment of the current frame and the interval duration (Frametime) of the acquisition of the adjacent frame. In addition, since the exposure starting moment of each frame is consistent with its acquisition starting moment, the camera cleaning control apparatus may determine the exposure starting moment of the current frame based on the acquisition starting moment of the current frame.

Expotime is a preset exposure duration per frame. In an example, FIG. 5 is an exposure diagram of a camera according to an embodiment of the present disclosure. As shown in FIG. 5, within an exposure duration of each frame, a camera exposes pixels of the frame line by line, starting with a first line, and then starts to expose a second line after the first line is exposed, and so on. Accordingly, after the exposure is over, the camera may read out data of the frame line by line. As shown in FIG. 4, Readtime indicates a read-out duration of data of each frame, Linetime indicates a read-out duration of data of each line in each frame, and Data indicates read-out data.

Next, the camera cleaning control apparatus may determine the exposure ending moment of the current frame according to the acquisition starting moment of the current frame and the preset exposure duration. Specifically, the exposure ending moment of the current frame is the acquisition starting moment of the current frame plus the preset exposure duration. Then, according to the acquisition starting moment of the current frame and the interval duration of the acquisition of the adjacent frame, an acquisition starting moment of the next frame is determined. Specifically, the acquisition starting moment of the next frame is the acquisition starting moment of the current frame plus the interval duration of the acquisition of the adjacent frame. The cleaning period may be determined based on the exposure ending moment of the current frame and the acquisition starting moment of the next frame.

The cleaning period (Cleantime) is within the period from the end of the exposure of the current frame to the beginning of the acquisition of the next frame, which is Frametime-Expotime.

By the camera cleaning control method provided in this embodiment, the acquisition starting moment of the current frame and the interval duration of the acquisition of the adjacent frame are determined according to the synchronization signal, then the exposure starting moment of the current frame is determined, and then the exposure ending moment of the current frame is determined according to the acquisition starting moment of the current frame and the preset exposure duration. Moreover, the cleaning period is determined based on the exposure ending moment of the current frame and the interval duration of the acquisition of the adjacent frame, where the cleaning period is within the period from the end of the exposure of the current frame to the beginning of the acquisition of the next frame, which is a blanking period of the work of the camera, so as to ensure the matching between the cleaning period and the working sequence of the camera, and thus avoid the impact of the cleaning of the camera on the image acquisition of the camera.

On the basis of the above embodiment 2, in order to further illustrate the camera cleaning control method of this embodiment, the step 102 includes: according to the synchronization signal, determining whether the exposure of the current frame has ended at the current moment; if the exposure of the current frame is not completed, the step of determining the cleaning period of the target camera based on the synchronization signal is performed; if the exposure of the current frame has ended, a remaining duration between the current moment and the beginning of the acquisition of the next frame is determined according to the synchronization signal; if the remaining duration reaches a preset threshold, the step of determining the cleaning period of the target camera according to the synchronization signal is performed; and if the remaining duration does not reach the preset threshold, the next frame is determined as the current frame and the step of determining the cleaning period of the target camera according to the synchronization signal is performed.

In this embodiment, since the current frame may be in different processing stages under the current moment, it is necessary to adopt corresponding methods to determine the cleaning period of the target camera for different processing stages.

Specifically, the camera cleaning control apparatus may determine whether the exposure of the current frame has ended at the current moment according to the synchronization signal. If the exposure of the current frame is not completed, it is indicated that the current frame is in the exposure stage, and the remaining duration between the current moment and the beginning of the acquisition of the next frame must be greater than the duration of the cleaning period, which means that the remaining duration is sufficient to complete the cleaning, then the step of determining the cleaning period of the target camera according to the synchronization signal in the embodiment 2 of this application may be performed.

Accordingly, if the exposure of the current frame has ended, it is indicated that the remaining duration between the current moment and the beginning of the acquisition of the next frame may not be greater than the duration of the cleaning period, which means that the remaining duration is not sufficient to complete the cleaning. At this time, the camera cleaning control apparatus may determine the remaining duration between the current moment and the beginning of the acquisition of the next frame according to the synchronization signal.

If the remaining duration reaches the preset threshold, it is indicated that the remaining duration is sufficient to complete the cleaning. In a possible implementation, the camera cleaning control apparatus may determine the cleaning period based on the current moment and the threshold. The starting moment of the cleaning period is the current moment, and the duration of the cleaning period is the threshold.

If the remaining duration does not reach the preset threshold, it is indicated that the remaining duration must not be sufficient to complete the cleaning, then the camera cleaning control apparatus may determine the next frame as the current frame and perform the step of determining the cleaning period of the target camera according to the synchronization signal in the embodiment 2 of this application.

Through the above method, the cleaning period of the target camera may be further determined according to different processing stages of the current frame under the current moment, and the matching between the cleaning period and the working sequence of the camera may be further ensured.

### Embodiment 3

FIG. 6 is a flowchart of a camera cleaning control method according to an embodiment of the present disclosure. As shown in FIG. 6, the camera cleaning control method provided by this embodiment includes following steps:
a step 301, determining a target camera that is currently required to be cleaned, where the target camera currently uses a first lens;
a step 302, determining a switching period of the first lens according to a synchronization signal, where the switching period is within a period from the end of the exposure of a current frame to the beginning of the acquisition of a next frame; and
a step 303, switching the currently used lens to a second lens during the switching period, and cleaning the first lens after the switching is completed, where the second lens is a lens other than the first lens among a plurality of lenses arranged in the camera.

It is required to be noted that an execution body of the camera cleaning control method provided in this embodiment may be a camera cleaning control apparatus. In practical applications, the camera cleaning control apparatus may be implemented by computer programs, such as application software and computer programs, or by media on which related computer programs are stored, such as an USB flash disk and a CD; alternatively, the camera cleaning control apparatus may be implemented by physical apparatuses that integrate or install related computer programs, such as a chip.

In this embodiment, the camera is equipped with a plurality of lenses, and the number of lenses is not limited in this embodiment. In order to implement camera cleaning without affecting camera image acquisition, after the camera that is required to be cleaned is determined, it is necessary to determine the switching period of the lens according to the synchronization signal of the camera, perform lens switching during the switching period, and clean the lens used by the camera that is required to be cleaned before the lens switching after the switching is completed, which means that the period after completion of the switching is the cleaning period of the first lens used before the lens switching. Specifically, since there may be a plurality of cameras in a car, such as a front-view camera, a rear-view camera, and a round-view camera, the camera cleaning control apparatus may first determine the target camera that is currently required to be cleaned among the plurality of cameras, where the lens currently used by the target camera is the first lens.

The number of target cameras may be one or more, which is not limited in this embodiment. Accordingly, the number of first lenses may also be one or more.

In an example, in order to determine the target camera that is currently required to be cleaned, the camera cleaning control apparatus may obtain images acquired by each camera and detect lens attachments of the images acquired by each camera. A specific detection method is not limited in this embodiment. Next, the camera cleaning control apparatus may, according to detection results of the images acquired by each camera, determine a camera whose detection result is that there is an attachment as the target camera that is currently required to be cleaned.

Next, the camera cleaning control apparatus may determine the switching period of the first lens according to the synchronization signal. A specific determination method will be detailed in the following and will not be repeated here.

The switching period is within the period from the end of the exposure of the current frame to the beginning of the acquisition of the next frame.

It is required to be noted that since there may be synchronization applications between cameras, it is necessary to make each camera work in accordance with the same working sequence, so a signal controlling the work of each camera is synchronized, which is the synchronization signal.

In addition, the current frame refers to a frame that is being processed or has been processed at a current moment, where the processing includes, but is not limited to, acquisition, exposure, and reading.

Finally, the camera cleaning control apparatus may switch the currently used lens to the second lens during the switching period, where the second lens is the lens other than the first lens among the plurality of lenses. Moreover, the camera cleaning control apparatus may clean the first lens during the cleaning period of the first lens, which means that the camera cleaning control apparatus may clean the first lens after the switching is completed. A specific switching method will be detailed in the following and will not be repeated here.

In a possible implementation, the camera cleaning control apparatus may clean the first lens using different cleaning methods. Specifically, the camera cleaning control apparatus may first determine a type of attachment corresponding to the target camera. A specific determination method is not limited in this embodiment.

The type of attachment includes, but is not limited to, a raindrop, a snowflake, a stain, and a piece of paper.

Next, the camera cleaning control apparatus may clean the first lens using a corresponding cleaning method according to the type of attachment. The cleaning method includes at least one of followings: water jet cleaning, wiper cleaning, and air jet cleaning. For example, in practical applications, if the type of attachment is the raindrop, the first lens may be cleaned by the wiper cleaning; if the type of attachment is the stain, such as mud, the first lens may be cleaned by the water jet cleaning and the wiper cleaning at the same time; and if the type of attachment is the piece of paper, the first lens may be cleaned by the air jet cleaning.

In the above way, the first lens may be cleaned using corresponding cleaning methods according to different attachment types, so as to ensure cleaning effect.

In addition, in an example, the camera cleaning control apparatus may clean the first lens during a preset cleaning period. For example, the preset cleaning period may be a period from a switching completion moment to a 5th second after the switching is completed. Thus, the first lens may be cleaned in time without affecting next lens switching.

In another example, the camera cleaning control apparatus may determine a cleaning period and a degree of cleaning according to a current weather condition, and clean a first lens to the corresponding degree during the determined cleaning period. Specifically, the camera cleaning control apparatus may determine the current weather condition through an image acquired by the camera, or by obtaining weather data, or by other appropriate methods, which is not limited in this embodiment. For example, if the camera cleaning control apparatus determines that the current weather condition is heavy rain, the camera cleaning control apparatus may determine that the cleaning period is a period from a switching completion moment to a 1st second after the switching is completed, and the degree of cleaning is intensive cleaning. If the camera cleaning control apparatus determines that the current weather condition is fine, the camera cleaning control apparatus may determine that the cleaning period is a period from a switching completion moment to a 5th second after the switching is completed, and the degree of cleaning is ordinary cleaning.

In the above way, the cleaning period and the degree of cleaning may be determined according to different weather conditions, so that the first lens may be cleaned in time and cleaning effect may be ensured.

By the camera cleaning control method provided in this embodiment, according to the synchronization signal, the switching period of the first lens currently used by the target camera that is currently required to be cleaned is determined, where the switching period is within the period from the end of the exposure of the current frame to the beginning of the acquisition of the next frame. Moreover, during the switching period, the currently used lens is switched to the lenses other than the first lens among the plurality of lenses, which is the second lens, and after the switching is completed, the first lens is cleaned. In other words, in this disclosed embodiment, the camera may be equipped with the plurality of lenses. When the first lens currently used by the target camera is required to be cleaned, the period from the end of the exposure of the current frame to the beginning of the acquisition of the next frame may be acquired according to the synchronization signal, and during this period, the first lens is switched to the second lens. Because in this period, information of the current frame has been stored, and the acquisition of the next frame has not started, it is ensured that the switching of the lens during the determined switching period will not affect the image acquisition of the target camera. In addition, cleaning the first lens after the switching is completed further ensures the image acquisition of the target camera.

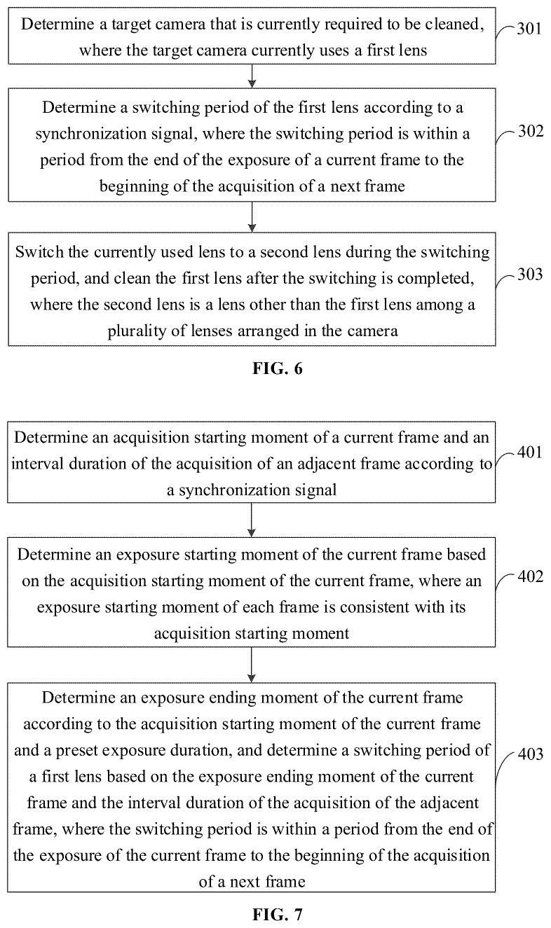

As an example, FIG. 7 is a flowchart of a camera cleaning control method according to an embodiment of the present disclosure. As shown in FIG. 7, the camera cleaning control method provided in this embodiment is based on the above embodiment, and the step 302 specifically includes following steps:
a step 401, determining an acquisition starting moment of a current frame and an interval duration of the acquisition of an adjacent frame according to the synchronization signal;
a step 402, determining an exposure starting moment of the current frame based on the acquisition starting moment of the current frame, where an exposure starting moment of each frame is consistent with its acquisition starting moment; and
a step 403, determining an exposure ending moment of the current frame according to the acquisition starting moment of the current frame and a preset exposure duration, and determining the switching period of the first lens based on the exposure ending moment of the current frame and the interval duration of the acquisition of the adjacent frame, where the switching period is within the period from the end of the exposure of the current frame to the beginning of the acquisition of the next frame.

In this disclosed embodiment, the camera cleaning control apparatus may determine the switching period of the first lens according to the synchronization signal. Specifically, in an example, FIG. 4 is a working sequence diagram of a camera according to an embodiment of the present disclosure. As shown in FIG. 4, Pclk is a working clock inside the camera, which may be doubled by a phase locked loop (PLL) inside the camera according to an external reference clock. Additionally, the working sequence inside the camera is acquired all based on this working clock.

Vsync is a synchronization signal. In a possible implementation, this synchronization signal may be generated within the camera based on the Pclk and frame_interval configuration. In another possible implementation, this synchronization signal may be provided by an external apparatus (such as a sync generator), which may output a synchronization signal at a fixed frequency, such as 30 Hz or 60 Hz.

According to the synchronization signal, the camera cleaning control apparatus may determine the acquisition starting moment of the current frame and the interval duration (Frametime) of the acquisition of the adjacent frame. In addition, since the exposure starting moment of each frame is consistent with its acquisition starting moment, the camera cleaning control apparatus may determine the exposure starting moment of the current frame based on the acquisition starting moment of the current frame.

Expotime is a preset exposure duration per frame. In an example, FIG. 5 is an exposure diagram of a camera according to an embodiment of the present disclosure. As shown in FIG. 5, within an exposure duration of each frame, a camera exposes pixels of the frame line by line, starting with a first line, and then starts to expose a second line after the first line is exposed, and so on. Accordingly, after the exposure is over, the camera may read out data of the frame line by line. As shown in FIG. 4, Readtime indicates a read-out duration of data of each frame, Linetime indicates a read-out duration of data of each line in each frame, and Data indicates read-out data.

Next, the camera cleaning control apparatus may determine the exposure ending moment of the current frame according to the acquisition starting moment of the current frame and the preset exposure duration. Specifically, the exposure ending moment of the current frame is the acquisition starting moment of the current frame plus the preset exposure duration. Then, according to the acquisition starting moment of the current frame and the interval duration of the acquisition of the adjacent frame, an acquisition starting moment of the next frame is determined. Specifically, the acquisition starting moment of the next frame is the acquisition starting moment of the current frame plus the interval duration of the acquisition of the adjacent frame. The switching period of the first lens may be determined based on the exposure ending moment of the current frame and the acquisition starting moment of the next frame.

The switching period (Switchtime) is within the period from the end of the exposure of the current frame to the beginning of the acquisition of the next frame, which is Frametime-Expotime.

By the camera cleaning control method provided in this embodiment, the acquisition starting moment of the current frame and the interval duration of the acquisition of the adjacent frame are determined according to the synchronization signal, then the exposure starting moment of the current frame is determined, and then the exposure ending moment of the current frame is determined according to the acquisition starting moment of the current frame and the preset exposure duration. Moreover, the switching period of the first lens is determined based on the exposure ending moment of the current frame and the interval duration of the acquisition of the adjacent frame, where the switching period is within the period from the end of the exposure of the current frame to the beginning of the acquisition of the next frame, which is a blanking period of the work of the camera, so as to ensure the matching between the switching period and the working sequence of the camera, and thus avoid the impact of the lens switching on the image acquisition of the camera.

On the basis of the above embodiment 3, in order to further explain the camera cleaning control method of the present disclosure, the camera includes a switching apparatus, on which the plurality of lenses are arranged. In the step 303, switching the currently used lens to the second lens includes: controlling the operation of the switching apparatus to drive the plurality of lenses on the switching apparatus to shift until the second lens moves to a corresponding position of the first lens before the lens switching.

In this disclosed embodiment, the camera is equipped with the switching apparatus, and the plurality of lenses are arranged on the switching apparatus. Accordingly, when the currently used lens is switched to the second lens that is the lens other than the first lens among the plurality of lenses, the camera cleaning control apparatus may control the operation of the switching apparatus to drive the plurality of lenses on the switching apparatus to shift until the second lens moves to the corresponding position of the first lens before the lens switching.

The mode of operation of the switching apparatus may be rotating, reciprocating, or other suitable mode, which is not limited in this embodiment.

In an example, the switching apparatus includes a rotatable disc, the plurality of lenses are evenly distributed on the disc, and relative angles between adjacent lenses are equal. Accordingly, controlling the operation of the switching apparatus to drive the plurality of lenses on the switching apparatus to shift until the second lens moves to the corresponding position of the first lens before the lens switching includes: controlling the disc to rotate along a predetermined rotation direction, and a rotation angle is a relative angle.

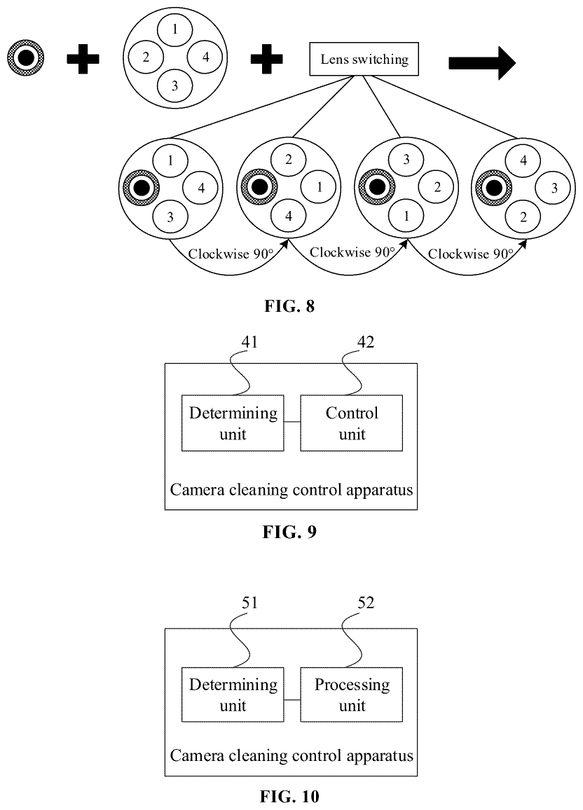

FIG. 8 is a schematic diagram of a switching apparatus according to an embodiment of the present disclosure. As shown in FIG. 8, the switching apparatus may be a rotatable disc, the number of lenses is four, the four lenses are evenly distributed on the disc, and relative angles between adjacent lenses are equal, all of which are 90 degrees. The camera cleaning control apparatus may control the disc to rotate 90 degrees clockwise to implement lens switching. In practical applications, the camera cleaning control apparatus may control the disc to rotate clockwise, or counterclockwise, or alternately rotate clockwise and counterclockwise, which is not limited in this embodiment.

In addition, in a possible implementation, if the number of lenses is two, the camera cleaning control apparatus may control the disc to rotate 180 degrees clockwise or counterclockwise to implement lens switching. Accordingly, if the number of lenses is three, the camera cleaning control apparatus may control the disc to rotate 120 degrees clockwise or counterclockwise to implement lens switching.

In another example, the switching apparatus may be a reciprocating mechanism, and the plurality of lenses are distributed on the reciprocating mechanism along the direction of motion of the reciprocating mechanism, and distances between adjacent lenses are equal. The direction of motion of the reciprocating mechanism may be horizontal, vertical, or other suitable direction of motion, which is not limited in this embodiment.

In practical applications, the camera cleaning control apparatus may control the reciprocating mechanism to perform a reciprocating movement, and the displacement of the reciprocating movement is the distance between adjacent lenses, so that the lens switching is implemented. For example, if the direction of motion of the reciprocating mechanism is horizontal, the number of lenses is four, and the distance between the adjacent lenses is 1 cm, the camera cleaning control apparatus may first determine which lens is the currently used first lens. If it is the currently used first lens is a first lens on the left side, the camera cleaning control apparatus controls the reciprocating mechanism to move 1 cm horizontally to the left to implement lens switching. If the currently used first lens is a first lens on the right side, the camera cleaning control apparatus controls the reciprocating mechanism to move 1 cm horizontally to the right to implement lens switching. If it is the currently used first lens is a second lens on the right side, the camera cleaning control apparatus controls the reciprocating mechanism to move 1 cm horizontally to the right or to the left to implement lens switching.

The camera cleaning control method provided in this embodiment may implement lens switching using different methods, thus laying a foundation for the implementation of the cleaning of the camera without affecting the image acquisition of the camera.

### Embodiment 4

Embodiment 4 of the present disclosure provides a camera cleaning control apparatus, including: a determining unit configured to determine a target camera that is currently required to be cleaned and determine a cleaning period of the target camera according to a synchronization signal; and a processing unit configured to clean the target camera during the cleaning period.

In an example, the determining unit is specifically configured to determine the target camera that is currently required to be cleaned, where the target camera currently uses a first lens; the determining unit is further specifically configured to determine a switching period of the first lens according to the synchronization signal, where the switching period is within a period from the end of the exposure of a current frame to the beginning of the acquisition of a next frame, and a period after completion of the switching is a cleaning period of the first lens; and the processing unit is specifically configured to switch the currently used lens to a second lens during the switching period and clean the first lens after the switching is completed, where the second lens is a lens other than the first lens among a plurality of lenses arranged in the camera.

In another example, the processing unit includes a control unit; the determining unit is specifically configured to determine the cleaning period of the target camera according to the synchronization signal, where the cleaning period is within the period from the end of the exposure of the current frame to the beginning of the acquisition of the next frame; and the control unit is configured to clean the target camera during the cleaning period.

### Embodiment 5

FIG. 9 is a structure diagram of a camera cleaning control apparatus according to an embodiment of the present disclosure. As shown in FIG. 9, the camera cleaning control apparatus provided in this embodiment includes: a determining unit 41 and a control unit 42. The determining unit 41 is configured to determine a target camera that is currently required to be cleaned. The determining unit 41 is further configured to determine a cleaning period of the target camera according to a synchronization signal, where the cleaning period is within a period from the end of the exposure of a current frame to the beginning of the acquisition of a next frame. The control unit 42 is configured to clean the target camera during the cleaning period.

The camera cleaning control apparatus provided in this embodiment determines the target camera that is currently required to be cleaned, determines the cleaning period of the target camera according to the synchronization signal, where the cleaning period is within the period from the end of the exposure of the current frame to the beginning of the acquisition of the next frame, and cleans the target camera during the cleaning period. In other words, in this disclosed embodiment, the period from the end of the exposure of the current frame to the beginning of the acquisition of the next frame may be acquired according to the synchronization signal, and during this period, the cleaning period of the target camera may be determined. Because in this period, information of the current frame has been stored, and the acquisition of the next frame has not started, it is ensured that the cleaning of the target camera during the determined cleaning period will not affect the image acquisition of the target camera.

In an optional implementation, the determining unit 41 is further configured to: determine an acquisition starting moment of the current frame and an interval duration of the acquisition of an adjacent frame according to the synchronization signal, determine an exposure starting moment of the current frame based on the acquisition starting moment of the current frame, where an exposure starting moment of each frame is consistent with its acquisition starting moment, determine an exposure ending moment of the current frame according to the acquisition starting moment of the current frame and a preset exposure duration, and determine the cleaning period based on the exposure ending moment of the current frame and the interval duration of the acquisition of the adjacent frame, where the cleaning period is within the period from the end of the exposure of the current frame to the beginning of the acquisition of the next frame.

In an optional implementation, the determining unit 41 is further configured to, according to the synchronization signal, determine whether the exposure of the current frame has ended at the current moment; if the exposure of the current frame is not completed, the determining unit 41 performs the step of determining the cleaning period of the target camera according to the synchronization signal; if the exposure of the current frame has ended, the determining unit 41 determines a remaining duration between the current moment and the beginning of the acquisition of the next frame according to the synchronization signal; if the remaining duration reaches a preset threshold, the determining unit 41 performs the step of determining the cleaning period of the target camera according to the synchronization signal; and if the remaining duration does not reach the preset threshold, the determining unit 41 determines the next frame as the current frame and performs the step of determining the cleaning period of the target camera according to the synchronization signal.

In an optional implementation, the determining unit 41 is further configured to determine the cleaning period based on the current moment and the threshold if the remaining duration reaches the preset threshold, where the starting moment of the cleaning period is the current moment, and the duration of the cleaning period is the threshold.

In an optional implementation, the determining unit 41 is further configured to obtain images acquired by each camera, detect lens attachments of the images acquired by each camera, and determine the target camera according to detection results of the images acquired by each camera, where a detection result of the target camera is that there is an attachment.

In an optional implementation, the determining unit 41 is further configured to determine a type of attachment corresponding to the target camera. The camera cleaning control apparatus further includes: a selecting unit configured to clean the target camera using a corresponding cleaning method according to the type of attachment, where the cleaning method includes at least one of followings: water jet cleaning, wiper cleaning, and air jet cleaning.

In an optional implementation, the camera cleaning control apparatus further includes: an acquiring unit and a returning unit. The acquiring unit is configured to acquire an image acquired by the target camera and detect the image. The returning unit is configured to return to perform the step of determining the cleaning period of the target camera according to the synchronization signal if the detection result of the target camera is that there is an attachment, otherwise, the returning unit is configured to return to perform the step of determining the target camera that is currently required to be cleaned.

It is required to be noted that the technical scheme and effect of the implementation of the camera cleaning control apparatus provided in this embodiment may be referred to relevant contents of the above-mentioned method embodiment and will not be repeated here.

### Embodiment 6

FIG. 10 is a structure diagram of a camera cleaning control apparatus according to an embodiment of the present disclosure. As shown in FIG. 10, the camera cleaning control apparatus provided in this embodiment includes: a determining unit 51 and a processing unit 52. The determining unit 51 is configured to determine a target camera that is currently required to be cleaned, where the target camera currently uses a first lens. The determining unit 51 is further configured to determine a switching period of the first lens according to a synchronization signal, where the switching period is within a period from the end of the exposure of a current frame to the beginning of the acquisition of a next frame. The processing unit 52 is configured to switch the currently used lens to a second lens during the switching period, and clean the first lens after the switching is completed, where the second lens is a lens other than the first lens among a plurality of lenses arranged in the camera.

The camera cleaning control apparatus provided in this embodiment, according to the synchronization signal, determines the switching period of the first lens currently used by the target camera that is currently required to be cleaned, where the switching period is within the period from the end of the exposure of the current frame to the beginning of the acquisition of the next frame. Moreover, during the switching period, the camera cleaning control apparatus switches the currently used lens to the lenses other than the first lens among the plurality of lenses, which is the second lens, and after the switching is completed, the camera cleaning control apparatus cleans the first lens. In other words, in this disclosed embodiment, the camera may be equipped with the plurality of lenses. When the first lens currently used by the target camera is required to be cleaned, the period from the end of the exposure of the current frame to the beginning of the acquisition of the next frame may be acquired according to the synchronization signal, and during this period, the first lens is switched to the second lens. Because in this period, information of the current frame has been stored, and the acquisition of the next frame has not started, it is ensured that the switching of the lens during the determined switching period will not affect the image acquisition of the target camera. In addition, cleaning the first lens after the switching is completed further ensures the image acquisition of the target camera.

In an optional implementation, the determining unit 51 is further configured to determine an acquisition starting moment of the current frame and an interval duration of the acquisition of an adjacent frame according to the synchronization signal, determine an exposure starting moment of the current frame based on the acquisition starting moment of the current frame, where an exposure starting moment of each frame is consistent with its acquisition starting moment, determine an exposure ending moment of the current frame according to the acquisition starting moment of the current frame and a preset exposure duration, and determine the switching period of the first lens based on the exposure ending moment of the current frame and the interval duration of the acquisition of the adjacent frame, where the switching period is within the period from the end of the exposure of the current frame to the beginning of the acquisition of the next frame.

In an optional implementation, the camera includes a switching apparatus, and the plurality of lenses are arranged on the switching apparatus. The processing unit 52 is further configured to control the operation of the switching apparatus to drive the plurality of lenses on the switching apparatus to shift until the second lens moves to a position corresponding to the first lens before lens switching.

In an optional implementation, the switching apparatus includes a rotatable disc, the plurality of lenses are evenly distributed on the disc, and relative angles between adjacent lenses are equal. The processing unit 52 is further configured to control the disc to rotate along a predetermined rotation direction, and a rotation angle is a relative angle.

In an optional implementation, the switching apparatus includes a reciprocating mechanism, and the plurality of lenses are distributed on the reciprocating mechanism along the direction of motion of the reciprocating mechanism, and distances between adjacent lenses are equal. The processing unit 52 is further configured to control the reciprocating mechanism to perform a reciprocating movement, and the displacement of the reciprocating movement is the distance.

In an optional implementation, the determining unit 51 is further configured to obtain images acquired by each camera, detect lens attachments of the images acquired by each camera, and determine the target camera according to detection results of the images acquired by each camera, where a detection result of the target camera is that there is an attachment.

In an optional implementation, the processing unit 52 is further configured to determine a type of attachment corresponding to the target camera, clean the first lens using a corresponding cleaning method according to the type of attachment, where the cleaning method includes at least one of followings: water jet cleaning, wiper cleaning, and air jet cleaning.

It is required to be noted that the technical scheme and effect of the implementation of the camera cleaning control apparatus provided in this embodiment may be referred to relevant contents of the above-mentioned method embodiment and will not be repeated here.

### Embodiment 7

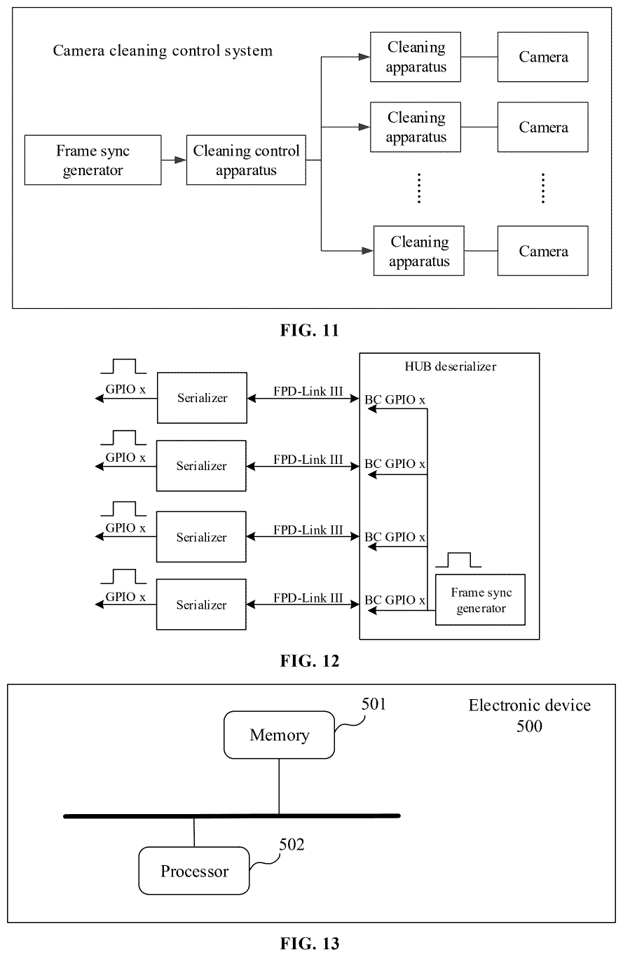

FIG. 11 is a schematic diagram of a camera cleaning control system according to an embodiment of the present disclosure. As shown in FIG. 11, in the camera cleaning control system provided in this embodiment, a synchronization signal is provided by a frame sync generator, and the camera cleaning control system provided in this embodiment includes: a cleaning control apparatus, a plurality of cleaning apparatuses, a frame sync generator, and a plurality of cameras. The plurality of cleaning apparatuses are arranged in one-to-one correspondence with the plurality of cameras.

The frame sync generator is connected to the cleaning control apparatus and is configured to generate and send a synchronization signal to the cleaning control apparatus.

The cleaning control apparatus is connected to the plurality of cleaning apparatuses and is configured to determine a target camera that is currently required to be cleaned and determine a cleaning period of the target camera according to the synchronization signal. The cleaning period is within a period from the end of the exposure of a current frame to the beginning of the acquisition of a next frame. During the cleaning period, the cleaning control apparatus controls a cleaning apparatus corresponding to the target camera to clean the target camera.

In a possible implementation, due to an installation position of a round-view camera, reverse rear-view camera, and the like, on a car is often separated from a central processing unit ranging from tens of centimeters to several meters, therefore, taking into account signal stability and wiring harness cost and other factors, the camera cleaning control system may use a serial transmission mode. Accordingly, the system further includes: a plurality of serializers that are arranged in one-to-one correspondence with the plurality of cameras. FIG. 12 is a schematic diagram of a working principle of a serializer according to an embodiment of the present disclosure. As shown in FIG. 12, a frame sync generator is connected to one end of the plurality of serializers. As an example, the frame sync generator may output a plurality of parallel synchronization signals through an HUB deserializer, and one end of the plurality of serializers and an output port of the HUB deserializer are connected one-to-one, where the output port of the HUB deserializer may be a general purpose input/output (GPIO) interface. The serializers and the HUB deserializer may communicate based on a flat panel display link (FPD Link). The FPD-Link III serial bus scheme supports full-duplex control for high-speed video data transmission and bidirectional control communication via a single differential link. Integrating video data and control through a single differential pair may reduce an interconnection line size and weight and also eliminate bias issues and simplify system design. The other end of the plurality of serializers may be connected one-to-one to the plurality of cameras through the GPIO interface, and the other end of at least one serializer is connected to the cleaning control apparatus. The plurality of serializers are configured to synchronize the synchronization signal generated by the frame sync generator to the plurality of cameras and the cleaning control apparatus according to a fixed frequency (such as 30 Hz or 60 Hz), so that the plurality of cameras may work according to the synchronization signal, and the cleaning control apparatus may determine the cleaning period of the camera according to the synchronization signal.

### Embodiment 8

FIG. 13 is a structural diagram of an electronic device according to an embodiment of the present disclosure. As shown in FIG. 13, the present disclosure also provides an electronic device 500, including a memory 501 and a processor 502.

The memory 501 is configured to store a program. Specifically, the program may include a program code, where the program code includes a computer execution instruction. The memory 501 may contain a high-speed RAM memory and also a non-volatile memory. For example, the memory 501 may contain at least one disk memory.

The processor 502 is configured to perform the program stored in the memory 501.

The computer program is stored in the memory 501 and is configured to be executed by the processor 502 to implement the camera cleaning control method provided by either embodiment of the present disclosure. The relevant description may be understood by referring to the corresponding description and effect of the steps in the attached drawings, and will not be repeated here.

In this embodiment, the memory 501 and the processor 502 are connected via a bus. The bus may be an industry standard architecture (ISA) bus, a peripheral component interconnect (PCT) bus, or an extended industry standard architecture (EISA) bus, and the like. The bus may be divided into an address bus, a data bus, and a control bus, and the like. For ease of representation, the bus is represented by only one thick line in FIG. 13, which does not mean that there is only one bus or one type of bus.

### Embodiment 9

This disclosed embodiment also provides a computer readable storage medium, on which a computer program is stored, where the computer program is executed by a processor to implement the camera cleaning control method provided by any embodiment of this application.

### Embodiment 10

This disclosed embodiment also provides a computer program product, including a computer program, where the camera cleaning control method provided by any embodiment of this application is implemented when the computer program is executed by a processor.

In several embodiments provided in this application, it should be understood that the disclosed apparatus and method may be implemented in other ways. For instance, the apparatus embodiments described above are merely illustrative. For instance, a division of units is only a logical function division. In an actual implementation, there may be other division methods. For instance, a plurality of units or components may be combined or may be integrated in another system, or some features may be ignored or may not be performed. In addition, the displayed or discussed mutual coupling or direct coupling or communication connection may be implemented through indirect coupling or communication connection of some interfaces, devices or units, and may be electrical or other forms.

Units described as separate components may or may not be physically separated. Components shown as units may or may not be physical units. In other words, the components may be located in one place or distributed to a plurality of network units. According to actual needs, some or all of the units can be selected for realizing the purposes of the examples of the present disclosure.

In addition, the functional units in each example of the present application may be integrated into one processing module, or each of the units may exist separately and physically, or two or more units may be integrated into one module. The integrated unit above may be implemented in the form of hardware or in the form of hardware plus software function units.

Program codes for implementing the method of this application may be written in any combination of one or more programming languages. These program codes may be provided to a processor or controller of a general purpose computer, special purpose computer, or other programmable camera cleaning control apparatus, so that the program codes, when executed by the processor or controller, implement functions/operations specified in the flowchart and/or block diagram. The program codes may be executed completely on a machine, partly on a machine, server as a stand-alone package to be executed partly on a machine and partly on a remote machine or completely on a remote machine.

In the context of this application, a machine readable medium may be a tangible medium that may contain or store a program for use by or in conjunction with an instruction execution system, apparatus, or device. The machine readable medium may be a machine readable signal medium or a machine readable storage medium. The machine readable medium includes, but is not limited to, electronic, magnetic, optical, electromagnetic, infrared, or semiconductor systems, apparatuses, or devices, or any suitable combination of the above. More specific examples of the machine readable storage medium include electrical connections based on one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the above.

In addition, although operations are depicted in a particular order, this should be understood as requiring that such operations be performed in the particular order shown or in a sequential order, or that all the operations depicted should be performed to achieve the desired result. In certain circumstances, multitasking and parallel processing may be advantageous. Similarly, although certain implementation details are included in the above discussion, these should not be interpreted as limiting the scope of this application. Certain features described in the context of a single embodiment may also be implemented in combination in a single implementation. Conversely, various features described in the context of a single implementation may also be implemented in a plurality of implementations individually or in any suitable sub-combination.

Those skilled in the art, after considering the specification and practicing the invention disclosed herein, will readily think of other embodiments of the present application. This application is intended to cover any variation, use or adaptation of this application that follows general principles of this application and includes common knowledge or customary techniques in the field of technology not disclosed in this application. The specification and embodiments are to be regarded as exemplary only, and the true scope and spirit of this application are indicated by the claims below.

It should be understood that this application is not limited to the precise structure already described above and shown in the attached drawings, and that various modifications and changes may be made without deviating from the scope of this application. The scope of this application is limited only by the attached claims. The above is only the specific implementation of this application, but the scope of protection of this application is not limited to this. Any change or replacement that may easily come to mind by any skilled person familiar with the technical field within the technical scope disclosed in this application shall be covered by the protection of this application. Therefore, the scope of protection in this application shall be governed by the scope of protection of the attached claims.

1-18. (canceled)

19. An electronic device, comprising: a memory and a processor, wherein
the memory is configured to store an executable instruction of the processor, wherein
the processor is configured to call a program instruction in the memory to perform the camera cleaning control, comprising:
determining a target camera that is currently required to be cleaned;
determining a cleaning period of the target camera according to a synchronization signal; and
cleaning the target camera during the cleaning period.

20-21. (canceled)

22. A camera cleaning system, comprising: a cleaning control apparatus, a plurality of cleaning apparatuses, a frame sync generator, and a plurality of cameras, wherein the plurality of cleaning apparatuses are arranged in one-to-one correspondence with the plurality of cameras;
the frame sync generator is connected to the cleaning control apparatus and is configured to generate and send a synchronization signal to the cleaning control apparatus; and
the cleaning control apparatus is connected to the plurality of cleaning apparatuses and is configured to: determine a target camera that is currently required to be cleaned, determine a cleaning period of the target camera according to the synchronization signal, wherein the cleaning period is within a period from the end of the exposure of a current frame to the beginning of the acquisition of a next frame, and control a cleaning apparatus corresponding to the target camera to clean the target camera during the cleaning period.

23. The system of claim 22, further comprising: a plurality of serializers that are arranged in one-to-one correspondence with the plurality of cameras, wherein
one end of the plurality of serializers is connected to the frame sync generator, the other end of the plurality of serializers is connected to the plurality of cameras one by one, and the other end of at least one serializer is connected to the cleaning control apparatus, wherein the plurality of serializers are configured to synchronously output the synchronization signal generated by the frame sync generator to the plurality of cameras and the cleaning control apparatus.

24. The electronic device of claim 19, wherein the camera is equipped with a plurality of lenses, and wherein the processor is configured to call the program instruction in the memory to determine the target camera that is currently required to be cleaned, comprising:
determining the target camera that is currently required to be cleaned, wherein the target camera currently uses a first lens;
wherein the processor is configured to call the program instruction in the memory to determine the cleaning period of the target camera according to the synchronization signal, comprising:
determining a switching period of the first lens according to the synchronization signal, wherein the switching period is within a period from the end of the exposure of a current frame to the beginning of the acquisition of a next frame, and a period after completion of the switching is a cleaning period of the first lens; and
wherein the processor is configured to call the program instruction in the memory to clean the target camera during the cleaning period, comprising:
switching the currently used lens to a second lens during the switching period and cleaning the first lens after the switching is completed, wherein the second lens is a lens other than the first lens among the plurality of lenses arranged in the camera.

25. The electronic device of claim 24, wherein the processor is configured to call the program instruction in the memory to determine the switching period of the first lens according to the synchronization signal, comprising:
determining an acquisition starting moment of the current frame and an interval duration of the acquisition of an adjacent frame according to the synchronization signal;
determining an exposure starting moment of the current frame based on the acquisition starting moment of the current frame, wherein an exposure starting moment of each frame is consistent with its acquisition starting moment; and
determining an exposure ending moment of the current frame according to the acquisition starting moment of the current frame and a preset exposure duration, and determining the switching period of the first lens based on the exposure ending moment of the current frame and the interval duration of the acquisition of the adjacent frame, wherein the switching period is within the period from the end of the exposure of the current frame to the beginning of the acquisition of the next frame.

26. The electronic device of claim 24, wherein the camera comprises a switching apparatus, on which the plurality of lenses are arranged, and wherein the processor is configured to call the program instruction in the memory to switch the currently used lens to the second lens, comprising:
controlling the operation of the switching apparatus to drive the plurality of lenses on the switching apparatus to shift until the second lens moves to a position corresponding to the first lens before lens switching.

27. The electronic device of claim 26, wherein the switching apparatus comprises a rotatable disc, on which the plurality of lenses are evenly distributed, relative angles between adjacent lenses are equal, and wherein the processor is configured to call the program instruction in the memory to control the operation of the switching apparatus to drive the plurality of lenses on the switching apparatus to shift until the second lens moves to the position corresponding to the first lens before lens switching, comprising
controlling the disc to rotate along a predetermined rotation direction, wherein a rotation angle is a relative angle; or
wherein the switching apparatus comprises a reciprocating mechanism, on which the plurality of lenses are distributed along the direction of movement of the reciprocating mechanism, distances between adjacent lenses are equal, and wherein the processor is configured to call the program instruction in the memory to control the operation of the switching apparatus to drive the plurality of lenses on the switching apparatus to shift until the second lens moves to the position corresponding to the first lens before lens switching, comprising controlling the reciprocating mechanism to perform a reciprocating movement, wherein the displacement of the reciprocating movement is the distance.

28. The electronic device of claim 24, wherein the processor is configured to call the program instruction in the memory to determine the target camera that is currently required to be cleaned, comprising:
obtaining images acquired by each camera, and detecting lens attachments of the images acquired by each camera; and
determining the target camera according to detection results of the images acquired by each camera, wherein a detection result of the target camera is that there is an attachment.

29. The electronic device of claim 28, wherein the processor is configured to call the program instruction in the memory to clean the first lens, comprising:
determining a type of attachment corresponding to the target camera; and
cleaning the first lens using a corresponding cleaning method according to the type of attachment, wherein the cleaning method comprises at least one of followings: water jet cleaning, wiper cleaning, and air jet cleaning.

30. The electronic device of claim 19, wherein the processor is configured to call the program instruction in the memory to determine the cleaning period of the target camera according to the synchronization signal, comprising:
determining an acquisition starting moment of the current frame and an interval duration of the acquisition of an adjacent frame according to the synchronization signal;
determining an exposure starting moment of the current frame based on the acquisition starting moment of the current frame, wherein an exposure starting moment of each frame is consistent with its acquisition starting moment;
determining an exposure ending moment of the current frame according to the acquisition starting moment of the current frame and a preset exposure duration, and determining the cleaning period based on the exposure ending moment of the current frame and the interval duration of the acquisition of the adjacent frame, wherein the cleaning period is within a period from the end of the exposure of a current frame to the beginning of the acquisition of a next frame; or
determining whether the exposure of the current frame has ended at a current moment according to the synchronization signal;
determining the cleaning period of the target camera according to the synchronization signal if the exposure of the current frame is not completed; and
determining a remaining duration between the current moment and the beginning of the acquisition of the next frame according to the synchronization signal if the exposure of the current frame has ended; determining the cleaning period of the target camera according to the synchronization signal if the remaining duration reaches a preset threshold; and determining the next frame as the current frame and determining the cleaning period of the target camera according to the synchronization signal if the remaining duration does not reach the preset threshold.

31. The electronic device of claim 33, wherein the processor is configured to call the program instruction in the memory to determine the cleaning period of the target camera according to the synchronization signal if the remaining duration reaches the preset threshold, comprising:
determining the cleaning period based on the current moment and the preset threshold if the remaining duration reaches the preset threshold, wherein a starting moment of the cleaning period is the current moment, and a duration of the cleaning period is the preset threshold.

32. The electronic device of claim 30, wherein the processor is configured to call the program instruction in the memory to determine the target camera that is currently required to be cleaned, comprising:
obtaining images acquired by each camera, and detecting lens attachments of the images acquired by each camera; and
determining the target camera according to detection results of the images acquired by each camera, wherein a detection result of the target camera is that there is an attachment.

33. The electronic device of claim 32, wherein the processor is configured to call the program instruction in the memory to determine the target camera that is currently required to be cleaned, further comprising:
determining a type of attachment corresponding to the target camera; and
cleaning the target camera using a corresponding cleaning method according to the type of attachment, wherein the cleaning method comprises at least one of followings: water jet cleaning, wiper cleaning, and air jet cleaning.

34. The electronic device of claim 19, wherein after the target camera is cleaned during the cleaning period, the processor is configured to call the program instruction in the memory to perform the camera cleaning control, further comprising:
acquiring an image acquired by the target camera, and detecting the image; and
returning to determine the cleaning period of the target camera according to the synchronization signal if the detection result of the target camera is that there is an attachment, otherwise, returning to determine the target camera that is currently required to be cleaned.

35. A camera cleaning control method, comprising:
determining a target camera that is currently required to be cleaned;
determining a cleaning period of the target camera according to a synchronization signal; and
cleaning the target camera during the cleaning period.

36. The method of claim 35, wherein the camera is equipped with a plurality of lenses, and determining the target camera that is currently required to be cleaned comprises:
determining the target camera that is currently required to be cleaned, wherein the target camera currently uses a first lens;
determining the cleaning period of the target camera according to the synchronization signal comprises:
determining a switching period of the first lens according to the synchronization signal, wherein the switching period is within a period from the end of the exposure of a current frame to the beginning of the acquisition of a next frame, and a period after completion of the switching is a cleaning period of the first lens; and
cleaning the target camera during the cleaning period comprises:
switching the currently used lens to a second lens during the switching period, and cleaning the first lens after the switching is completed, wherein the second lens is a lens other than the first lens among the plurality of lenses arranged in the camera.

37. The method of claim 36, wherein determining the switching period of the first lens according to the synchronization signal comprises:
determining an acquisition starting moment of the current frame and an interval duration of the acquisition of an adjacent frame according to the synchronization signal;
determining an exposure starting moment of the current frame based on the acquisition starting moment of the current frame, wherein an exposure starting moment of each frame is consistent with its acquisition starting moment; and
determining an exposure ending moment of the current frame according to the acquisition starting moment of the current frame and a preset exposure duration, and determining the switching period of the first lens based on the exposure ending moment of the current frame and the interval duration of the acquisition of the adjacent frame, wherein the switching period is within the period from the end of the exposure of the current frame to the beginning of the acquisition of the next frame.

38. The method of claim 36, wherein the camera comprises a switching apparatus, on which the plurality of lenses are arranged, and switching the currently used lens to the second lens comprises:
controlling the operation of the switching apparatus to drive the plurality of lenses on the switching apparatus to shift until the second lens moves to a position corresponding to the first lens before lens switching.

39. The method of claim 38, wherein the switching apparatus comprises a rotatable disc, on which the plurality of lenses are evenly distributed, relative angles between adjacent lenses are equal, and controlling the operation of the switching apparatus to drive the plurality of lenses on the switching apparatus to shift until the second lens moves to the position corresponding to the first lens before lens switching comprises:
controlling the disc to rotate along a predetermined rotation direction, wherein a rotation angle is a relative angle.

40. The method of claim 38, wherein the switching apparatus comprises a reciprocating mechanism, on which the plurality of lenses are distributed along the direction of movement of the reciprocating mechanism, distances between adjacent lenses are equal, and controlling the operation of the switching apparatus to drive the plurality of lenses on the switching apparatus to shift until the second lens moves to the position corresponding to the first lens before lens switching comprises:
controlling the reciprocating mechanism to perform a reciprocating movement, wherein the displacement of the reciprocating movement is the distance.
